(19) United States
(12) Patent Application Publication
(10) Pub. No.: US 2011/0112944 A1
(43) Pub. Date: May 12, 2011

(54) METHOD AND DEVICE FOR STORING NAMES FOR NONPUBLISHED NUMBERS ON TELEPHONE BILL

(75) Inventor: Robert Ingman, Sr., Peachtree City, GA (US)

(73) Assignee: AT&T INTELLECTUAL PROPERTY I, L.P., Reno, NV (US)

(21) Appl. No.: 12/614,524

(22) Filed: Nov. 9, 2009

(51) Int. Cl. G06Q 30/00; G06F 17/30; G06Q 40/00

(52) U.S. Cl. 705/34; 707/741; 707/E17.002

(57) ABSTRACT

A method and device are provided for storing names for nonpublished numbers on a telephone bill. A telephone bill is displayed that includes published numbers and nonpublished numbers. For each nonpublished number, an option is provided to associate names to the nonpublished numbers. An associated name is received to correspond to a corresponding nonpublished number. The associated name is mapped to the corresponding nonpublished number in a mapping table, such that when the corresponding nonpublished number is displayed on the telephone bill the associated name is displayed. The associated name and the corresponding nonpublished number are stored in the mapping table.

### BACKGROUND

Exemplary embodiments relate to nonpublished numbers, and more particularly to, providing names for nonpublished numbers on telephone bills.

Many times various telephone numbers appear on telephone bills. Some numbers may be nonpublished numbers that have no phone owner data such as name and address associated with the nonpublished number. Particularly, nonpublished numbers such as mobile phones also referred to as cell phones do not have phone ownership data associated with the number. So even if ownership data for published numbers can be found using directory assistance, YELLOW PAGES™, WHITE PAGES™, for nonpublished (or unpublished) numbers there is no data.

### BRIEF SUMMARY

Exemplary embodiments include a method for storing names for nonpublished numbers on a telephone bill. A telephone bill is displayed that includes published numbers and nonpublished numbers. For each nonpublished number, an option is provided to associate names to the nonpublished numbers. An associated name is received to correspond to a corresponding nonpublished number. The associated name is mapped to the corresponding nonpublished number in a mapping table, such that when the corresponding nonpublished number is displayed on the telephone bill the associated name is displayed. The associated name and the corresponding nonpublished number are stored in the mapping table.

Exemplary embodiments include a method for storing names for mobile numbers on a telephone bill. A telephone bill is displayed that includes mobile numbers. For each mobile number, an option is provided to associate names to the mobile numbers. An associated name is received to correspond to a corresponding mobile number. The associated name is mapped to the corresponding mobile number in a mapping table, such that when the corresponding mobile number is displayed on the telephone bill the associated name is displayed. The associated name and the corresponding mobile number are stored in the mapping table.

Other systems, methods, apparatus, and/or computer program products according to embodiments will be or become apparent to one with skill in the art upon review of the following drawings and detailed description. It is intended that all such additional systems, methods, apparatus, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram in accordance with exemplary embodiments;

FIG. 2 illustrates a view of an example phone bill with nonpublished telephone numbers in accordance with exemplary embodiments;

FIG. 3 illustrates a mapping table in accordance with exemplary embodiments;

FIG. 4 illustrates a view of an example phone bill with nonpublished telephone numbers in accordance with exemplary embodiments;

FIG. 5 illustrates a method for storing names for nonpublished numbers on a telephone bill in accordance with exemplary embodiments;

FIG. 6 illustrates a method for storing names for mobile numbers on a telephone bill in accordance with exemplary embodiments; and

FIG. 7 illustrates a computer having elements utilized in exemplary embodiments.

The detailed description explains exemplary embodiments, together with features, by way of example with reference to the drawings.

### DETAILED DESCRIPTION OF EXEMPLARY EMBODIMENTS

Exemplary embodiments provide users with various options for telephone bills. For nonpublished telephone numbers and mobile (cell) phone numbers on telephone bills, exemplary embodiments provide one or more applications that are configured to allow a user to link nonpublished telephone numbers to created names that are respectively associated with the nonpublished telephone number and to allow a user to link the mobile phone numbers to created names that are respectively associated with the mobile phone numbers. Exemplary embodiments provide the applications to create, link, and display names for nonpublished listings and mobile (cell) phone numbers in current and subsequent telephone bills. The term phone bills and telephone bills can include landline phone bills, cable phone bills, soft phone bills, and/or mobile phone bills.

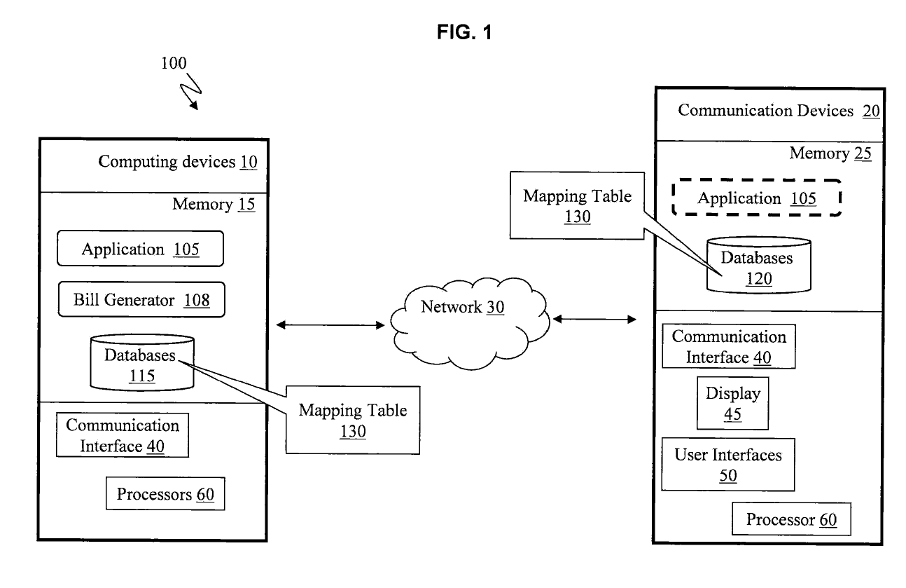

Now turning to FIG. 1, FIG. 1 illustrates a block diagram 100 in accordance with exemplary embodiments. In FIG. 1, one or more computing devices 10 are operatively connected to one or more communication devices 20 over a network 30.

The computing device 10 and the communication device 20 may include one or more processors 60 and may respectively include memory 15 and 25 which comprise a computer readable storage medium. The computing device 10 may include application 105 and bill generator application 180 and the communication device 20 may also include an identical application 105, all of which are configured with computer executable instructions to implement exemplary embodiments discussed herein. The applications 105 may include and/or represent numerous software components for carrying out the operations and functions of exemplary embodiments. Although the applications 105 are illustrated as two separate software components, they may be the same, and may fully, partially, and/or interchangeably reside on the computing device 10 and/or the communication device 20. The application 105 in the communication device 20 is illustrated with dashed lines to show that the application 105 may be downloaded to the communication device 20.

The memory 15 and 25 may include one or more databases 115 and 120. The computing device 10 and communication device 20 include communication interfaces 40, such as the software and hardware understood by one skilled in the art for communicating over the network 30. The communication device 20 may include a display 45 and a user interface 50. The user interfaces 50 may include, e.g., a mouse, track ball, pointing devices, keyboard, etc., for inputting commands.

The computing devices 10 may include a plurality of servers, network equipment, telephone equipment, etc., for monitoring telephone usage and providing telephone bills for individual users as understood by one skilled in the art.

Further regarding the network 30, the network 30 may include circuit-switched and/or packet-switched technologies and devices, such as routers, switches, hubs, gateways, etc., for facilitating communications. The network 30 may include wireline and/or wireless components utilizing, e.g., IEEE 802.11 standards for providing over-the-air transmissions of communications. The network 30 can include IP-based networks for communication between a customer service center and clients/users. The network 30 can manage multiple accounts as established by particular users. These accounts may then be used to provide access to services as described herein. Also, the network 30 may include wireline and/or wireless components utilizing standards, e.g., multimedia messaging services (MMS). The network 30 may include a multimedia messaging center (MMC), which implements the network side of multimedia messaging service (MMS) and makes it possible for an operator to offer multimedia messaging to mobile communication device users. The network 30 can include a managed IP and/or wireless network administered by a service provider, which can control bandwidth and quality of service for the communications discussed herein. The network 30 may be implemented in a wireless fashion, e.g., using wireless protocols and technologies, such as Wi-Fi®, WiMAX™, Bluetooth®, etc. The network 30 can also be a packet-switched network, such as a local area network, a wide area network, a metropolitan area network, an Internet network, or other similar types of networks. The network 30 may be a cellular communications network, a fixed wireless network, a wireless local area network (LAN), a wireless wide area network (WAN), a personal area network (PAN), a virtual private network (VPN), an intranet or any other suitable network, and the network 30 may include equipment for receiving and transmitting signals, such as a cell tower, a mobile switching center, a base station, and a wireless access point.

Via the application 105, the user of communication device 20 can view his or her phone bill (which may include a landline phone bill and a mobile phone bill) by operatively connecting to the computing device 10. Also, the user of communication device 20 may have downloaded (in whole or part) the application 105 to view his or her phone bill when operatively connected to (application 105 of) the computing device 10. The partial or whole application 105 of the communication device 20 operates in conjunction with the application 105 of the computing device 10 and/or the communication device 20 may not contain any portion of the application 105.

The application 105 is operative to display the phone bill and allow the phone bill to be manipulated by the user of the communication device 20. Unlike conventional phone bills that only show the telephone number, city, state, time, and/or length of call, in exemplary embodiments the application 105 provides options for the user of the communication device 20 to associate a name to each telephone number listed on the phone bill. Also, the application 105 is operative to allow any name to be changed that is presented on a phone bill.

The user of the communication device 20 can input a name (or nickname) to be associated with each telephone number (e.g., nonpublished) listed on the phone bill. The application 105 maps the input name to each corresponding telephone number in a mapping table 130. The mapping table 130 may be stored in the database 120 of the communication device 20 and/or in the database 115 of the computing device 10. For each name input by the user to correspond with a particular telephone number, the mapping table 130 stores the association between the two.

In the computing device 10, a bill generator application 108 is operative to generate a phone bill for the user. For example, if the bill generator application 108 generates a mobile (cell) phone bill, the bill generator application 108 is operative to select mobile phone data from the database 115 to generate the mobile phone bill. For example, if the bill generator application 108 generates a landline phone bill, the bill generator application 108 is operative to select landline phone data from the database 115 to generate the landline phone bill.

So when the bill generator application 108 generates a phone bill, which can be for a landline phone and/or mobile phone, the bill generator application 108 is operative to access and search the mapping table 130 to determine if any telephone numbers to be listed in the current phone bill are stored in the mapping table 130. If there are telephone numbers to be listed in the current phone bill stored in the mapping table 130, the bill generator application 108 is operative to locate and extract the corresponding name associated with each of the telephone numbers and add the corresponding name on the current phone bill with the corresponding telephone phone number. As such, the current phone bill and each subsequent phone bill will show the associated name beside the corresponding telephone number for the user of the communication device 20.

The bill generator application 108 is operative to generate phone bills for display on the display 45 of the communication device 20 and to generate paper phone bills to be sent by mail to the user. Via the application 105 and the bill generator application 108, both the paper phone bill and the electronic phone bill can show the associated name along with the corresponding telephone number.

Further regarding the mapping table 130, the mapping table 130 is a table in which the user (via the user interface 50) can maintain the names associated with nonpublished telephone numbers (including both landline telephone numbers and cell phone numbers) so that when the user's bill arrives, the user can immediately recognize each number associated with all of the user's phone calls.

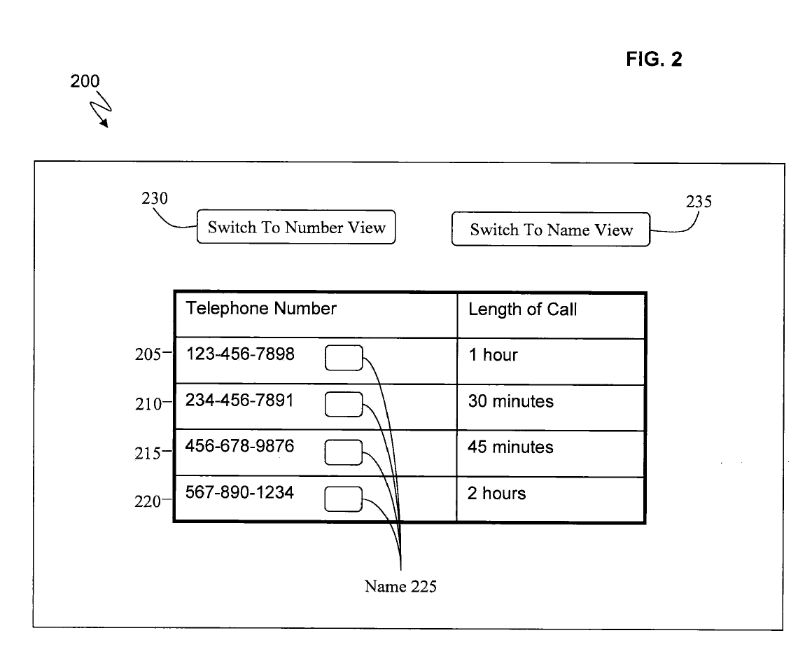

FIG. 2 illustrates a view 200 of an example phone bill with nonpublished telephone numbers, such as cell phone numbers and/or landline numbers that have no data linked to the number. For example, published numbers may indicate the owner of the phone line (whether mobile or landline), the address, etc. However, nonpublished numbers do not provide such information. Although the view 200 of the phone bill only shows nonpublished numbers for explanation purposes only, it is understood that both published and nonpublished phone numbers are included in the phone bill illustrated in the view 200.

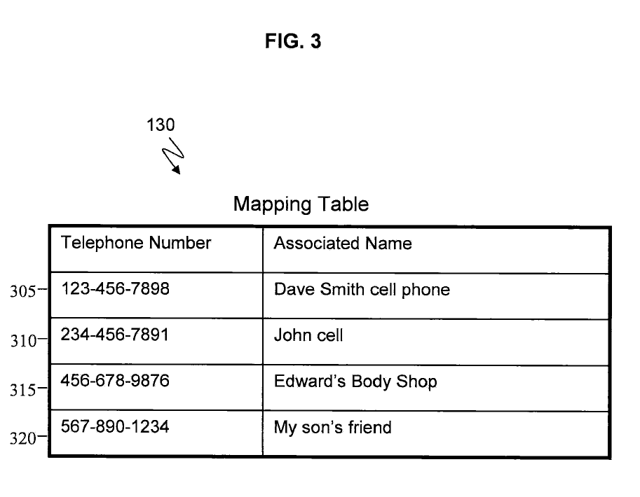

In the view 200, the phone bill illustrates the telephone number in the first column and the length of call in the second column, and although additional information may be included in the phone bill as understood by one skilled in the art, the additional information is omitted for conciseness. The user of the communication device 20 is presented with an option to associate a name to each nonpublished number as a name button 225. Optionally, the user may associate a name to published numbers as well. For example, the user may select the button 225 for the telephone number in box 205 via the user interface 50. After selecting the button 225, the user can input a name to be associated with the telephone number in the box 205. Also, the user can select the corresponding button 225 for each telephone number in boxes 210, 215, and 220, so that a name is associated with each of the telephone numbers in boxes 210, 215, and 220. The telephone numbers in the boxes 205, 210, 215, and 220 are stored in the mapping table 130 along with their respective associated names as shown in FIG. 3.

Turning to FIG. 3, FIG. 3 illustrates an example of the mapping table 130 in which the user of the communication device 20 has input names to correspond with the nonpublished numbers listed in the view 200 of FIG. 2 in accordance with exemplary embodiments.

In row 305, the mapping table 130 shows the telephone number 123-456-7898 from the phone bill in the view 200 and shows the associated name Dave Smith cell phone that has been input by the user via the user interface 50. Now, whenever the telephone number 123-456-7898 is generated by the bill generator application 108 for subsequent bills, the bill generator application 108 will include the associated name Dave Smith cell phone as shown in row 305. Likewise, in rows 310, 315, and 320, the telephone numbers 234-456-7891, 456-678-9876, 567-890-1234 are respectively associated with the names John cell, Edward's body shop, and My son's friend. Also, in exemplary embodiments, when the phone bill is displayed on the display 45 with only telephone numbers as illustrated in view 200, the application 105 can display the phone with the associated names by accessing the mapping table 130.

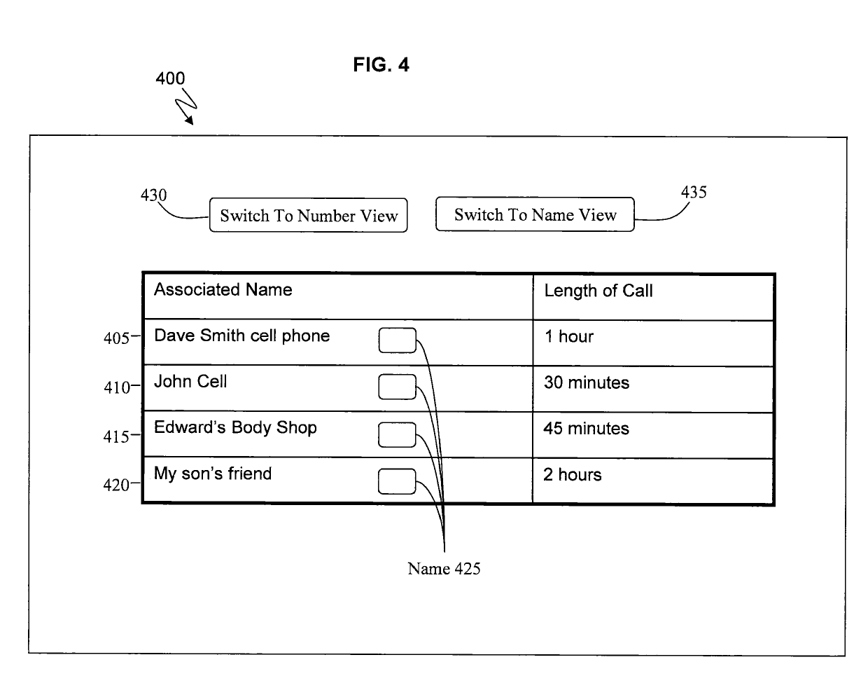

Additionally, exemplary embodiments provide a toggle mechanism that switches the display of the phone bill from the number to the name associated with the number. For example, FIG. 2 illustrates an example of a number view 200 in which the telephone numbers are shown on the telephone phone bill along with other telephone bill information. At the top of the view 200, buttons 230 and 235 allow the user of the computing device 10 to switch between the number view 200 and a name view 400 that is illustrated in FIG. 4. In FIG. 4, buttons 430 and 435 allow the user of the communication device 20 to switch between the name view 400 and the number view 200.

As seen in FIG. 4, the name view 400 shows the associated name in the first column that corresponds to the telephone numbers in the number view 200. By utilizing the buttons 230, 235, 430, and 435 the user can switch between viewing the phone bill with the associated names and/or the phone bill with the telephone numbers. In the name view 400, the remaining information that corresponds to each telephone number will correspond with the associated name. For instance, the length of call 1 hour for Dave Smith cell phone in the view 400 is the same as the length of call for the corresponding telephone number 123-456-7898.

Also, if the user had published and nonpublished numbers in his phone bill, the user can associate a name with each nonpublished telephone number via the application 105 so that any subsequent bills generated by the bill generator application 108 will display the associated names by extracting the associated names from the mapping table 300 for any corresponding telephone numbers. If the user's phone bill shows 50 different telephone numbers in the view 200 and the user would prefer to view 50 different associated names, the user can select button 230 in FIG. 2. Accordingly, the application 105 is operative to display the name view 400 showing 50 associated names as requested by the user. If the name view 400 shows any number on the phone bill when associated names should be displayed, the user can select the name button 425 corresponding to that particular number and input a name as discussed herein. If the user's bill shows 50 associated names in the name view 400, the user can select the button 435 in FIG. 4 to switch to the number view 200. Accordingly, the application 105 is operative to display the number view 200 as requested by the user of the communication device 20.

Further, for paper phone bills that may be generated by the bill generator application 108, when the user selects button 235 to switch to the name view 400 via the application 105, the application 105 causes the bill generator application 108 to add an additional column containing the associated names in the paper phone bill.

In accordance with exemplary embodiments, the application 105 allows the user to keep up with his calling patterns and those of his family regarding calls to friends and family members. When a number is shown on the phone bill that does not have a corresponding name, the user will know that the name needs to be added in his mapping table 130 via the application 105, which also allows the user to keep track of his children's calling patterns. For example, the user may input the associated name My son's friend to correspond with the telephone number 567-890-1234 as shown in the mapping table 130 and the view 400.

In accordance with one exemplary embodiment, the mapping table 130 can be completely stored on the communication device 20 in the database 120 (and not stored on the computing device 10) and the bill generator application 108 does not add associated names to the phone bill. When the user of the communication device 20 operatively connects to the computing device 10 to view the phone bill (both the landline phone bill and the mobile phone bill), the application 105 is configured to parse the mapping table 130 to determine if any telephone numbers in the mapping table 130 are listed on the phone bill. If any telephone numbers are found in the mapping table 130 by the application 105, the application 105 is operative to display the associated names for each number listed on the phone bill. In this example, the application 105 does not modify how the phone bill is generated by the bill generator application 108 but instead modifies how the phone bill is viewed and displayed by the user of the communication device 20. For example, the original phone bill may be a conventional telephone bill and after the user opens the original phone bill for display on the display 45, the application 105 is operative to (e.g., residing on the communication device 20) insert the buttons 225, 230, and 235 to be displayed as the name view 200. The application 105 can search the mapping table 130 (e.g., residing on the communication device 20) and determine telephone numbers having associated names. The application 105 is configured to allow the user to select to display on the display 45 the name view 400.

Further in exemplary embodiments, although the application 105 and the bill generator application 108 are shown as two separate application, the application 105 and the bill generator application 108 may be configured as one software application having many software components to operate and functions as discussed herein.

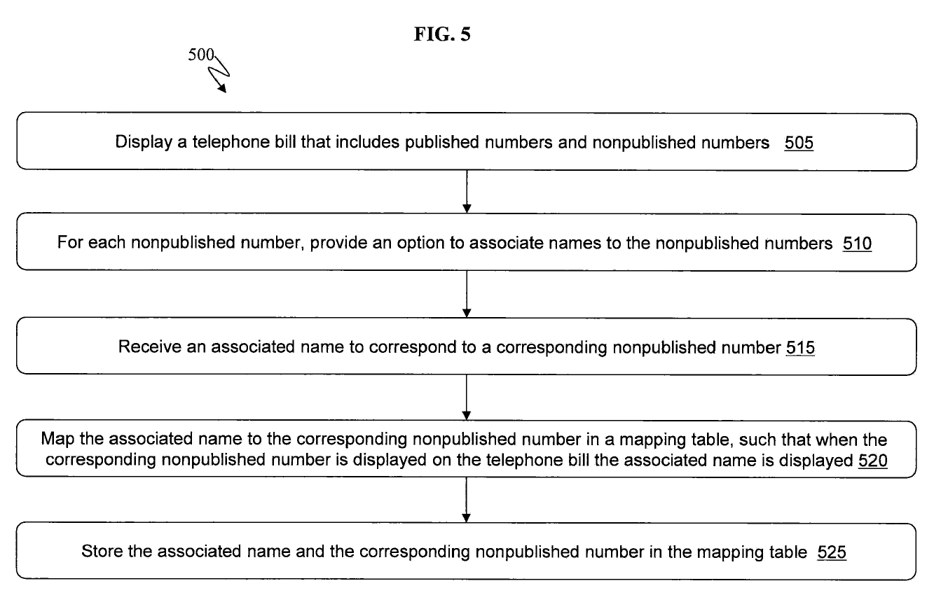

FIG. 5 illustrates a method 500 for storing names for nonpublished numbers on a telephone bill in accordance with exemplary embodiments. The application 105 is operative to display a telephone bill that includes published numbers and nonpublished numbers at 505.

For each nonpublished number, the application 105 is operative to provide an option to associate names to the nonpublished numbers at 510.

The application 105 is operative to receive an associated name to correspond to a corresponding nonpublished number at 515.

The application 105 is operative to map the associated name to the corresponding nonpublished number in a mapping table, such that when the corresponding nonpublished number is displayed on the telephone bill the associated name is displayed at 520.

The application 105 is operative to store the associated name and the corresponding nonpublished number in the mapping table at 525.

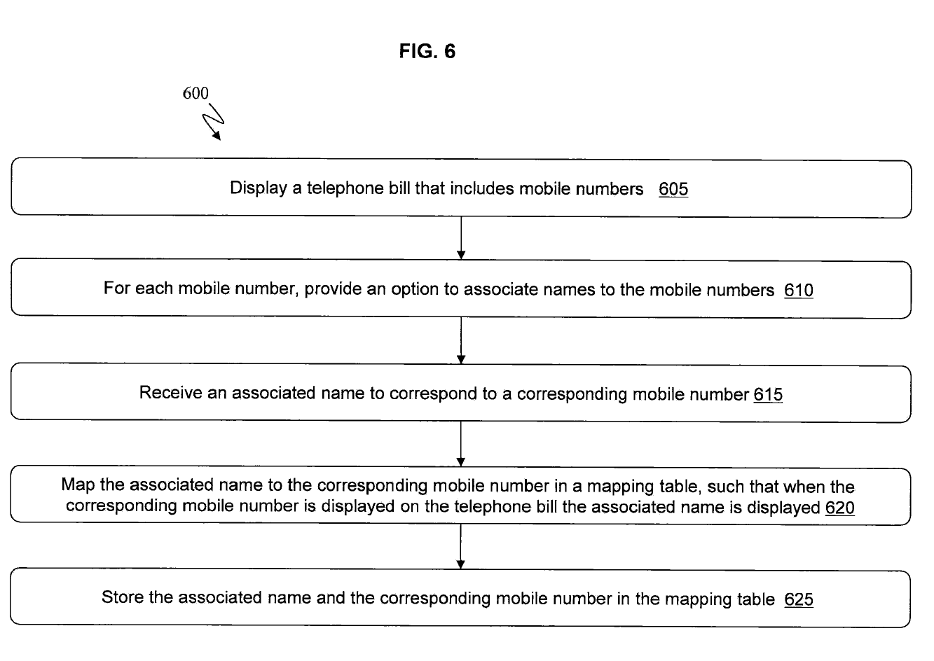

FIG. 6 illustrates a method 600 for storing names for mobile numbers on a telephone bill in accordance with exemplary embodiments.

The application 105 is operative to display a telephone bill that includes mobile numbers at 605.

For each mobile number, the application 105 is operative to provide an option to associate names to the mobile numbers at 610.

The application 105 is operative to receive an associated name to correspond to a corresponding mobile number at 615.

The application 105 is operative to map the associated name to the corresponding mobile number in a mapping table, such that when the corresponding mobile number is displayed on the telephone bill the associated name is displayed at 620.

The application 105 is operative to store the associated name and the corresponding mobile number in the mapping table at 625.

It is understood by one skilled in the art that each element described in the present disclosure contains all the necessary hardware, software, and/or firmware to operate and function as discussed herein in accordance with exemplary embodiments.

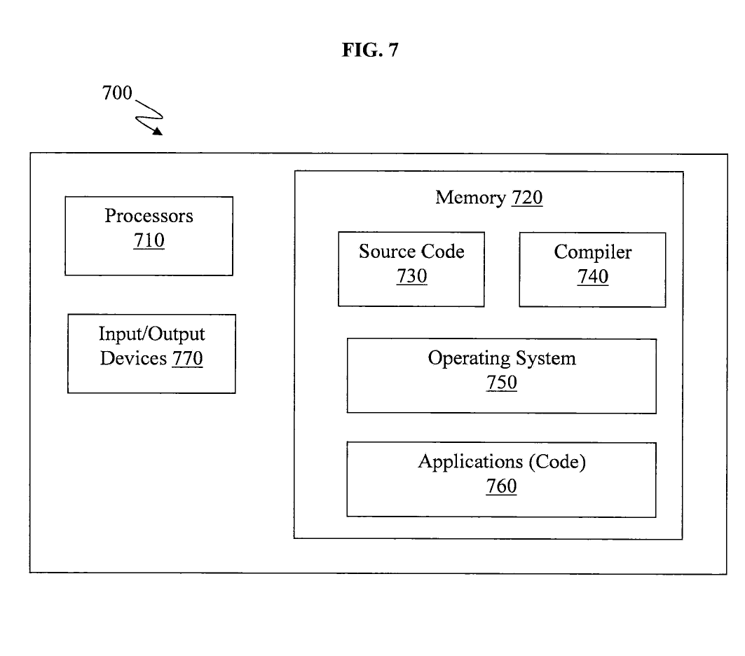

FIG. 7 illustrates an example of a computer 700 that may be utilized in implementing exemplary embodiments. For example, the computer 700 may have one or more elements that may be utilized in implementing the computing device 10 and communication device 20 in accordance with exemplary embodiments. The computer 700 includes, but is not limited to, PCs, workstations, systems, laptops, PDAs, palm devices, servers, mobile devices, communication devices, cell phones, computer systems, set top boxes (STB), televisions (TV), game consoles, MP3 players, and the like. The computer 700 may include one or more processors 710, memory 720, and one or more input and/or output (I/O) 770 devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 710 is a hardware device for executing software that can be stored in computer readable storage memory 720. The processor 710 can be virtually any custom made or commercially available processor, a central processing unit (CPU), a data signal processor (DSP), or an auxiliary processor among several processors associated with the computer 700, and the processor 710 may be a semiconductor based microprocessor (in the form of a microchip) or a macroprocessor.

The computer readable storage memory 720 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the computer readable storage memory 720 may incorporate electronic, magnetic, optical, and/or other types of storage media. Note that the computer readable storage memory 720 can have a distributed architecture, where various components are situated remote from one another, but can be accessed by the processor 710.

The software in the computer readable storage memory 720 may include one or more separate programs, each of which comprises an ordered listing of executable instructions for implementing logical functions. In the example illustrated in FIG. 7, the software in the computer readable storage memory 720 includes a suitable operating system (O/S) 750, compiler 740, source code 730, and one or more applications 760 (or modules) of the exemplary embodiments.

The operating system 750 controls the execution of other computer programs, and provides scheduling, input-output control, file and data management, memory management, and communication control and related services. It is contemplated by the inventors that the application 760 for implementing exemplary embodiments is applicable on all other commercially available operating systems.

The application 760 may be a source program, executable program (object code), script, or any other entity comprising a set of instructions to be performed. When a source program is to be executed, then the program is usually translated via a compiler (such as the compiler 740), assembler, interpreter, or the like, which may or may not be included within the computer readable storage memory 720, so as to operate properly in connection with the O/S 750. Furthermore, the application 760 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 770 may include input devices such as, for example but not limited to, a mouse, keyboard, scanner, microphone, remote controller, camera, biometric input device(s), a vibrator device for non-audible alert, etc. Furthermore, the I/O devices 770 may also include output devices, for example but not limited to, a printer, display, speaker, etc. Also, the I/O devices 770 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 770 include may include modems, gateways, receivers, transmitters, transceivers, etc. for communicating over a communications network.

When the computer 700 is in operation, the processor 710 is configured to execute software stored within the computer readable storage memory 720, to communicate data to and from the memory 720, and to generally control operations of the computer 700 pursuant to the software. The application 760 and the O/S 750 are read, in whole or in part, by the processor 710, perhaps buffered within the processor 710, and then executed.

When the application 760 is implemented in software, it should be noted that the application 760 can be stored on virtually any computer readable storage memory for use by or in connection with any computer related system or method. In the context of this document, a computer readable storage memory may be an electronic, magnetic, optical, or other physical device or means that can contain or store a computer program for use by or in connection with a computer related system or method.

The application 760 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, computer programs tangibly embodied on a computer-readable storage medium can be stored, communicated, propagated, or transported for use by or in connection with the instruction execution system, apparatus, or device.

More specific examples (a nonexhaustive list) of the computer-readable storage medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 760 is implemented in hardware, the application 760 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a computer readable storage medium, loaded into and/or executed by a computer. When the computer program code is loaded into an executed by a computer, the computer becomes an apparatus for practicing the exemplary embodiments. When implemented on a general-purpose microprocessor, the computer program code segments configure the microprocessor to create specific logic circuits. It is understood that computer program code can be transmitted over some transmission medium, loaded into and/or executed by a computer, or transmitted over some transmission medium, such as over electrical wiring or cabling, through fiber optics, or via electromagnetic radiation.

While features have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the present disclosure without departing from the essential scope thereof. Therefore, it is intended that the present disclosure not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for storing names for nonpublished numbers on a telephone bill, comprising:
displaying a telephone bill that includes published numbers and nonpublished numbers;
for each nonpublished number, providing an option to associate names to the nonpublished numbers;
receiving an associated name to correspond to a corresponding nonpublished number;
mapping the associated name to the corresponding nonpublished number in a mapping table, such that when the corresponding nonpublished number is displayed on the telephone bill the associated name is displayed; and
storing the associated name and the corresponding nonpublished number in the mapping table.

2. The method of claim 1, wherein on subsequent telephone bills, the associated name is displayed on the subsequent telephone bills in place of the corresponding nonpublished number.

3. The method of claim 1, wherein on subsequent telephone bills, the associated name is displayed on the subsequent telephone bills along with the corresponding nonpublished number, such that the associated name visually corresponds to the corresponding nonpublished number.

4. The method of claim 1, further comprising:
mapping a plurality of associated names to a plurality of corresponding nonpublished numbers, respectively;
wherein on subsequent telephone bills, the plurality of associated names are displayed.

5. The method of claim 1, further comprising generating a next month telephone bill for a user, wherein the next month telephone bill is subsequent to the telephone bill;
determining whether there is the mapping table for the user;
checking the mapping table for the nonpublished numbers for the next month telephone bill to determine if any of the nonpublished numbers have associated names; and
when corresponding associated names are in the mapping table, adding the associated names on the next month telephone bill to correspond with the corresponding nonpublished names.

6. The method of claim 5, wherein generating the next month telephone bill comprises generating a paper bill to mail to the user.

7. The method of claim 5, wherein generating the next month telephone bill comprises generating an electronic bill for display.

8. A method for storing names for mobile numbers on a telephone bill, comprising:
displaying a telephone bill that includes mobile numbers;
for each mobile number, providing an option to associate names to the mobile numbers;
receiving an associated name to correspond to a corresponding mobile number;
mapping the associated name to the corresponding mobile number in a mapping table, such that when the corresponding mobile number is displayed on the telephone bill the associated name is displayed; and
storing the associated name and the corresponding mobile number in the mapping table.

9. The method of claim 8, wherein on subsequent telephone bills, the associated name is displayed on the subsequent telephone bills in place of the corresponding mobile number.

10. The method of claim 8, wherein on subsequent telephone bills, the associated name is displayed on the subsequent telephone bills along with the corresponding mobile number, such that the associated name visually corresponds to the corresponding mobile number.

11. The method of claim 8, further comprising:
mapping a plurality of associated names to a plurality of corresponding mobile numbers, respectively;
wherein on subsequent telephone bills, the plurality of associated names are displayed.

12. The method of claim 8, further comprising generating a next month telephone bill for a user, wherein the next month telephone bill is subsequent to the telephone bill;
determining whether there is the mapping table for the user;
checking the mapping table for the mobile numbers for the next month telephone bill to determine if any of the mobile numbers have associated names; and
when corresponding associated names are in the mapping table, adding the associated names on the next month telephone bill to correspond with the mobile numbers.

13. The method of claim 12, wherein generating the next month telephone bill comprises generating a paper bill to mail to the user.

14. The method of claim 12, wherein generating the next month bill comprises generating an electronic bill for display.

15. The method of claim 8, further comprising:
mapping a plurality of associated names to a plurality of corresponding mobile numbers, respectively; and
providing a user with an option to switch between an associated name view and a mobile number view.

16. The method of claim 15, wherein the associated name view displays the plurality of associated names but not the plurality of corresponding mobile numbers.

17. The method of claim 15, wherein the mobile number view displays the plurality of corresponding mobile numbers but not the plurality of associated names.

18. The method of claim 15, further comprising:
receiving a selected view to the option to switch between the associated name view and a mobile number view; and
displaying the selected view.

19. A computing device, comprising:
memory for storing a program; and
a processor, functionally coupled to the memory, the processor being responsive to computer-executable instructions contained in the program and operative for:
displaying a telephone bill that includes mobile numbers;
for each mobile number, providing an option to associate names to the mobile numbers;
receiving an associated name to correspond to a corresponding mobile number;
mapping the associated name to the corresponding mobile number in a mapping table, such that when the corresponding mobile number is displayed on the telephone bill the associated name is displayed; and
storing the associated name and the corresponding mobile number in the mapping table.

20. The device of claim 19, further comprising:
mapping a plurality of associated names to a plurality of corresponding mobile numbers, respectively; and
providing a user with an option to switch between an associated name view and a mobile number view.
